(19) United States
(12) Patent Application Publication
(10) Pub. No.: US 2015/0191113 A1
(43) Pub. Date: Jul. 9, 2015

(54) MOTORCYCLE DOLLEY

(71) Applicant: Lee Frahm, Milwaukee, WI (US)

(72) Inventor: Lee Frahm, Milwaukee, WI (US)

(21) Appl. No.: 14/583,233

(22) Filed: Dec. 26, 2014

Related U.S. Application Data
(60) Provisional application No. 61/923,602, filed on Jan. 3, 2014.

(51) Int. Cl. B60P 1/43

(52) U.S. Cl. CPC B60P 1/433

(57) ABSTRACT

A motorcycle dolley comprises a chassis frame, a vehicle hitch extending from the chassis frame; a pair of wheels rotatably supported by the chassis frame, a chassis channel supported by the chassis frame to receive a front tire of a motorcycle, and a ramp. The ramp is hinged to the chassis channel to pivot between a lowered position in which the ramp extends towards an underlying terrain to roll the front tire the motorcycle up the ramp onto and into the channel and a raised position in which the ramp extends behind the front tire received within the channel.

### CROSS-REFERENCE TO RELATED PATENT APPLICATIONS

The present application claims priority under 35 USC Section 120 from co-pending U.S. Provisional Patent Application 61/923602 filed on Jan. 3, 2014 by Lee Frahm and entitled MOTORCYCLE DOLLEY, the full disclosure of which is hereby incorporated by reference.

### BACKGROUND

Transporting motorcycles is often difficult to achieve. Existing methods for transporting a motorcycle are complex and costly.

### BRIEF DESCRIPTION OF THE DRAWINGS

FIG. 1 is a perspective view of an example motorcycle dolley.

FIG. 2 is an enlarged fragmentary perspective view of a portion of the motorcycle dolley of FIG. 1 illustrating a hitch had a first height..

FIG. 3 is an enlarged fragmentary perspective view of the portion of the motorcycle dolley of FIG. 1 illustrating the hitch had a second height

FIG. 4 is a front perspective view of the motorcycle dolley of FIG. 1.

FIG. 5 is a fragmentary side view of the motorcycle Dolly of FIG. 1 receiving an example motorcycle for transport.

FIG. 6 is a fragmentary front perspective view of an alternative implementation of an example hitch of the motorcycle dolley of FIG. 1.

FIG. 7 is a fragmentary side perspective view of the hitch of FIG. 6.

### DETAILED DESCRIPTION OF THE EXAMPLE EMBODIMENTS

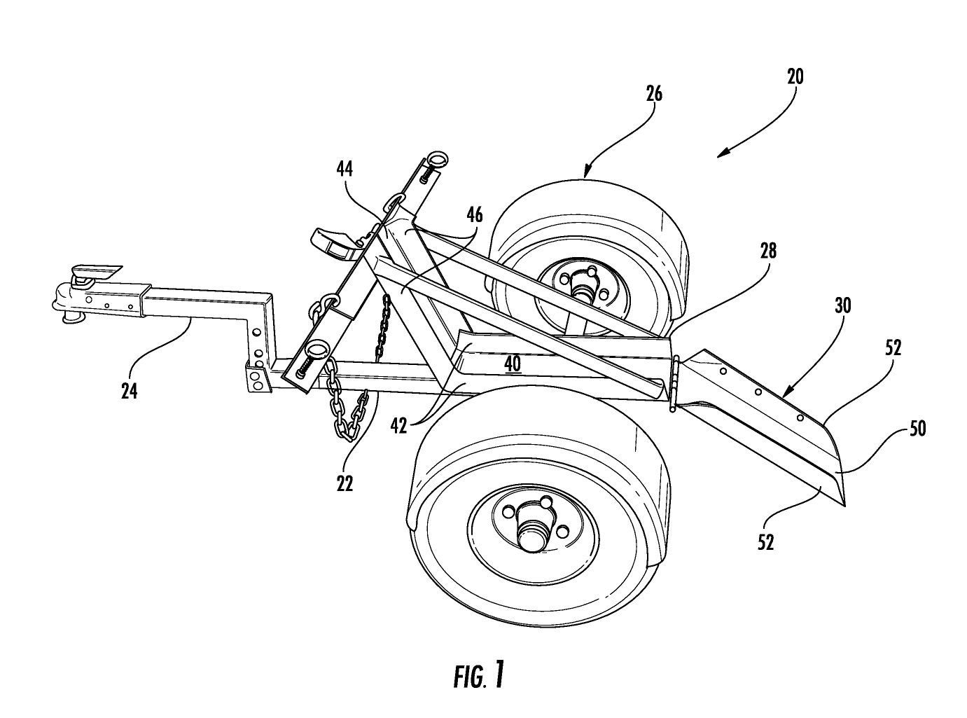

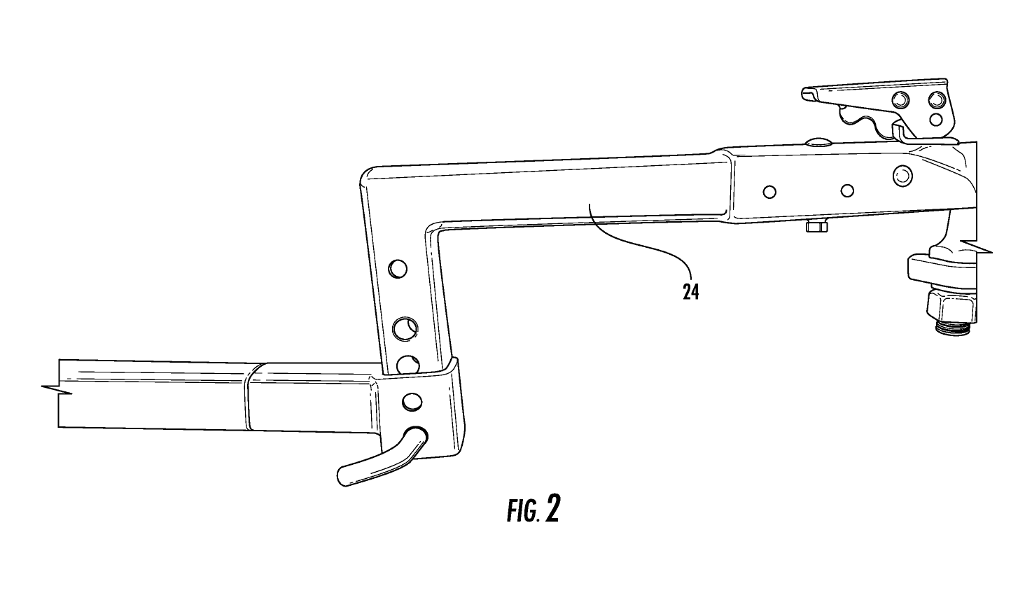

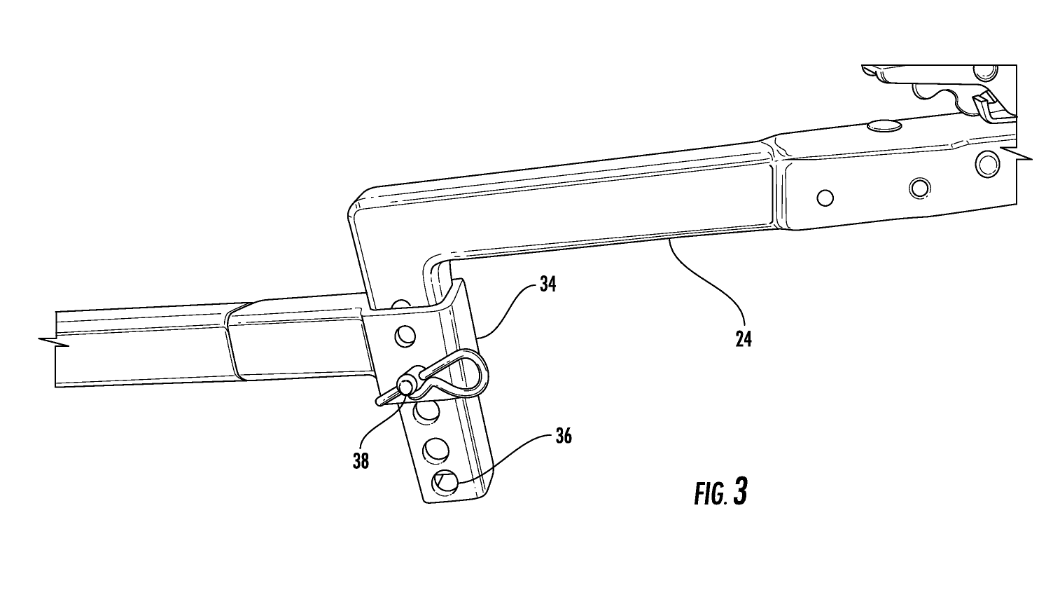

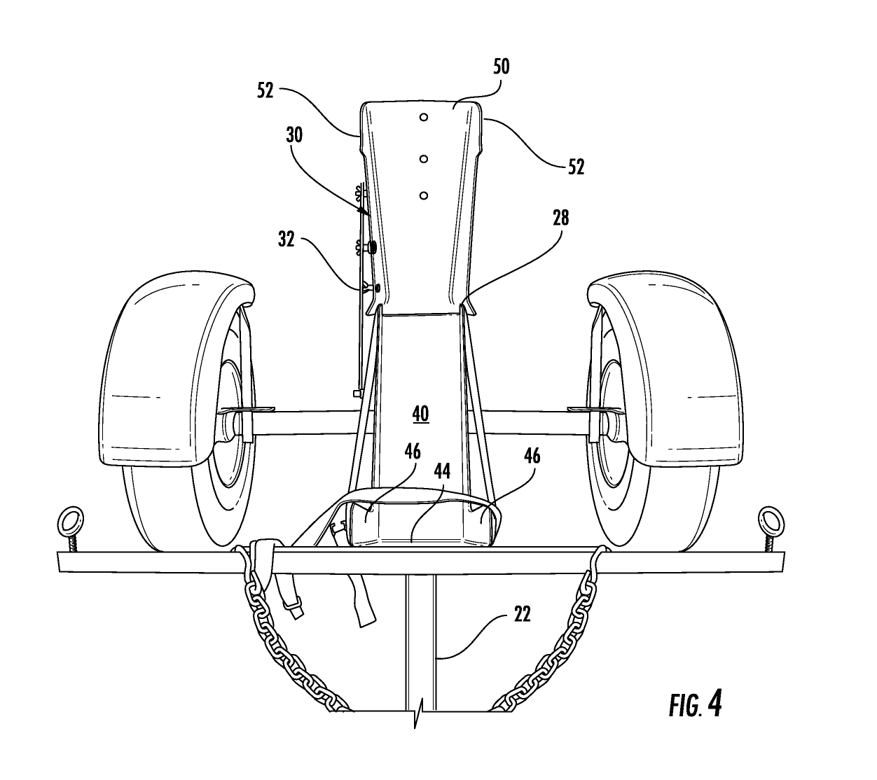

FIGS. 1-5 illustrate an example motorcycle dolley 20. Motorcycle dolley 20 is configured to transporting carry a powered cycle having a single front tire, such as a two wheeled motorcycle or a three wheeled motorcycle. Motorcycle dolley comprises chassis frame 22, hitch 24, wheels 26, chassis channel 28, ramp 30 and ramp securing link 32 (shown in FIG. 4). FIGS. 3 and 4 illustrate an example hitch 24. In the example illustrated, hitch 24 is vertically adjustable relative to chassis frame 22 to accommodate different vehicle hitch heights. In the example illustrated, hitch 24 comprises a sleeve 34 vertically slidable relative to chassis frame 22 is selectively securable in one of a plurality of openings 36 by a pin retainer 38. In other implementations, hitch 24 may be vertically adjustable utilizing other mechanisms or may not be vertically adjustable.

Chassis channel 28 comprises a forwardly and rearwardly extending track or groove comprising a horizontal portion configured to receive a front tire of a motorcycle. Chassis channel 28 comprises a horizontal floor 40 and a pair of opposing vertical sidewalls 42. Floor 40 underlies the received front tire sidewalls 42 inhibit transverse sliding of the front tire off of floor 40. Although not illustrated, in other implementations, sidewalls 42 may be transversely adjustable relative to one another to adjust the width of channel 28 to accommodate different front tires having different widths and two better retain the received tire against movement.

In the example illustrated, chassis channel 28 further comprises a vertical portion having a front wall 44 and a pair of opposing sidewalls 46. Front wall 44 is configured to abut a front surface of a received motorcycle front tire while sidewalls 46 abut or contact the front sidewalls of the front tire further assist in retaining the front tire the motorcycle in place during transport. To accommodate the curvature the tire, front wall 44 and sidewalls 46 obliquely extend from the lower horizontal portion of channel 28. In other implementations, front wall 44 and sidewalls 46 may extend at other angles from the lower portion of channel 28 or may be omitted.

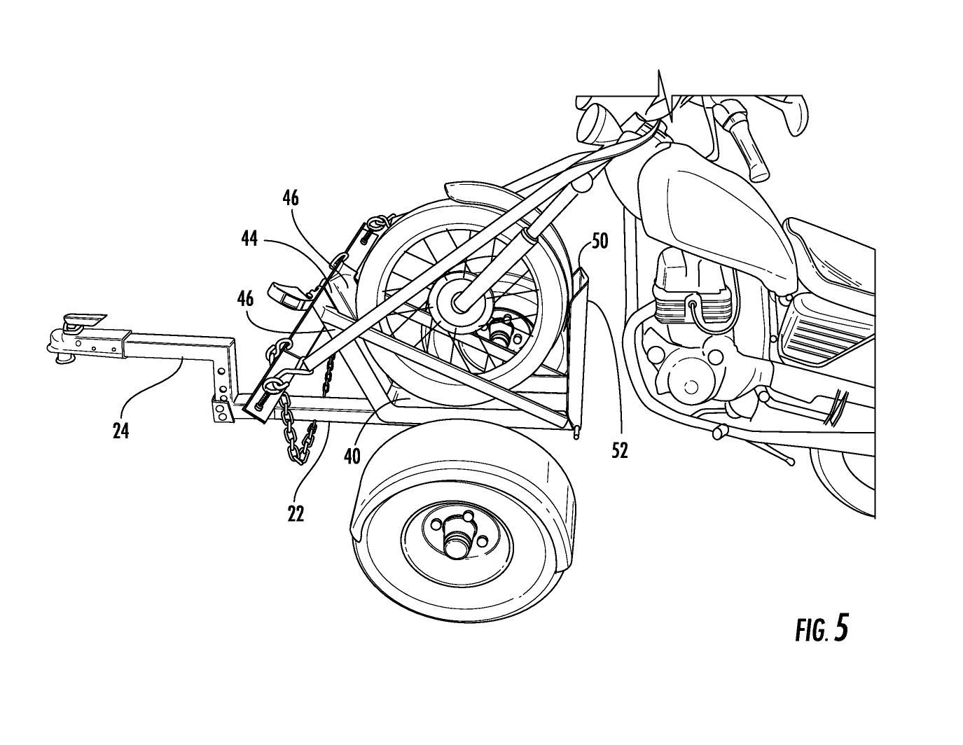

Ramp 30 comprises a surface pivotally coupled or hinged to channel 28 for pivotal movement between a lowered position (shown in FIG. 1) and a raised position (shown in FIGS. 4 and 5). In the lowered position, ramp 30 extends to ground allowing the front tire of the motorcycle to be rolled up ramp 30 into channel 28. In the raised position, showing FIG. 5, ramp 30 extends her projects behind the front motorcycle tire to assist in securing the front motorcycle tire in place during transport.

In the example illustrated, ramp 30 comprises a track or channel aligned with channel 28. In the example illustrated, ramp 30 comprises a floor 50 and a pair of opposing sidewalls 52. Sidewalls 52 project upwardly from floor 50 and serve as structures for guiding the movement a rolling of the front tire into channel 28. In the example illustrated, sidewalls 52 are parallel to one another. In yet another implementation, sidewalls 52 may obliquely extend relative to one another to form a funnel or narrowing track or channel which is wider at the ground level and which narrows towards channel 28 to guide movement of the front tire into a narrower channel 28. In yet other implementations, sidewalls 52 may be omitted.

FIG. 4 illustrates dolley 20 with ramp 30 in a raised position. In the example illustrated, as shown by FIG. 4, ramp securing link 32 retains ramp 30 in the raised position. In the example illustrated, link 32 comprises a rod or bar pivotally fastened to an extending between chassis frame 22 and ramp 30. In other implementations, other structures may be utilized to releasably secure ramp 30 in the raised position. In one implementation, ramp 30 may be resiliently biased by a spring towards the raised position. In one implementation, a powered actuator may be used to selectively raise and lower ramp 30. Examples of such a powered actuator include, but are not limited to, a hydraulic cylinder-piston assembly, a pneumatic cylinder-piston assembly, electric solenoid and the like.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

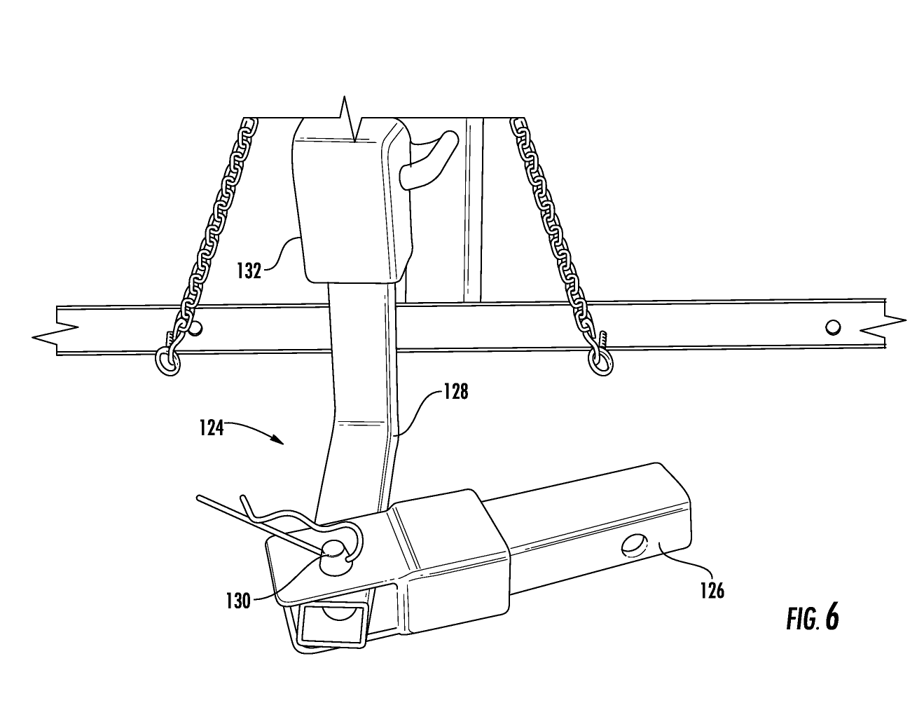

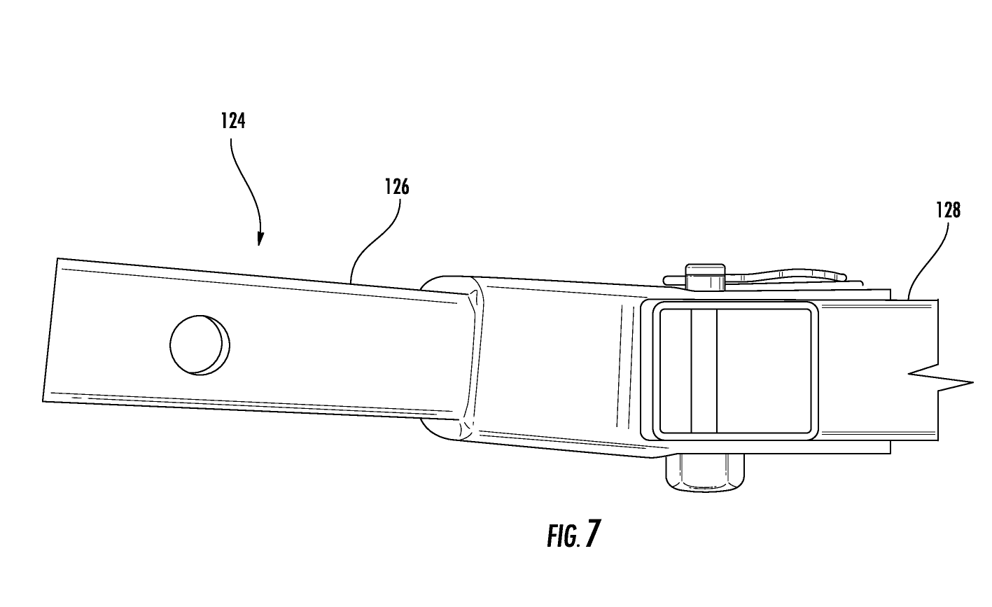

FIGS. 6 and 7 illustrate hitch 124, an alternative implementation of hitch 24. FIG. 6 is a front view of hitch 124 while FIG. 7 is a side view of hitch 124. Hitch 124 omits a ball type attachment point and instead directly comprises a shaft portion 126 which is received within a receiving portion of a vehicle hitch mount. As shown by FIG. 6, shaft portion 126 is pivotally connected to bar or shaft 128 which is coupled to the remainder of dolley 20. In the example illustrated, shaft portion 126 is pivotally coupled to shaft 128 by a vertically extending pin 130, allowing 126 to pivot or rotate about a vertical axis. Shaft portion 128 is pinned to a sleeve 132 which is coupled to the remainder of dolley 20, allowing the height of shaft 128 and shaft portion 126 to be adjusted to accommodate different vehicle hitch mount heights.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A motorcycle dolley comprising:
a chassis frame;
a vehicle hitch extending from the chassis frame;
a pair of wheels rotatably supported by the chassis frame;
a chassis channel supported by the chassis frame to receive a front tire of a motorcycle; and
a ramp hinged to the chassis channel to pivot between a lowered position in which the ramp extends towards an underlying terrain to roll the front tire the motorcycle up the ramp onto and into the channel and a raised position in which the ramp extends behind the front tire received within the channel.

2. The motorcycle dolley of claim 1, wherein the ramp comprises a track aligned with the chassis channel.

3. The motorcycle dolley of claim 1, wherein the ramp is configured to abut a rear of the front tire while the front tire is received within the channel.

4. The motorcycle dolley of claim 1, wherein the channel comprises a horizontal portion to underlie the front tire and a vertical portion to receive and extend in front of the front tire.

5. The motorcycle dolley of claim 1, wherein the vehicle hitch is vertically adjustable relative to the chassis frame.

6. The motorcycle dolley of claim 1, the vehicle hitch comprises a ball hitch.

7. The motorcycle dolley of claim 1 further comprising a ramp securing link for retaining the ramp in a raised position.

8. The motorcycle dolley of claim 1 further comprising a powered actuator to selectively raise and lower the ramp between a lowered position and a raised position.

9. The motorcycle dolley of claim 1, wherein the chassis channel has an adjustable width to restrict movement of the front tire within the channel.

10. The motorcycle dolley of claim 1, wherein the chassis channel extends between the pair of wheels.

11. A method comprising:
pivoting a ramp extending from a chassis frame towards ground to a lowered position;
rolling a front tire of a motorcycle up the ramp and into a chassis channel; and
pivoting the ramp to a raised position while the front tire is received within the chassis channel; and
securing the ramp in the raised position while the front tire is received within the chassis channel, wherein the ramp retains the front tire in the channel.
